(19) United States
(12) Patent Application Publication
(10) Pub. No.: US 2004/0193752 A1
(43) Pub. Date: Sep. 30, 2004

(54) System and method for providing fee-based data services

(76) Inventors: Harpreet Singh, Orange, CA (US); Louis Ormond, Irvine, CA (US); Michael Yeung, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/818,230

(22) Filed: Apr. 2, 2004

Related U.S. Application Data
(63) Continuation-in-part of application No. 10/746,530, filed on Dec. 24, 2003.
(60) Provisional application No. 60/437,644, filed on Jan. 2, 2003.

(51) Int. Cl. G06F 3/00

(52) U.S. Cl. 710/15

(57) ABSTRACT

A system and method to allow users in a non-office environment to access and use data services, such as scanning, printing, and distribution of documents and data and to charge the users for such services. Multifunctional peripheral devices are provided to service location providers for use by mobile users. A multifunctional peripheral device provider sells or leases the multifunctional peripheral device, related hardware and software, parts, and supplies to service location providers. The service location provider then provides access to the multiplication peripheral device and related services to mobile users. The user is then charged for the services used. The fees are paid to the multifunctional peripheral device provider. At least a portion of these fees are paid to any dealers involved in the sale or lease of the multifunctional peripheral device and to the service location providers. Any fees related to the sale or installation of the multifunctional peripheral device is also paid to the multifunctional peripheral device provider. At least a portion of these fees is paid to any dealers involved in the sale or lease of the multifunctional peripheral device.

### CROSS-REFERENCE TO RELATED APPLICATIONS

The present application is a continuation-in-part of U.S. application Ser. No. 10/746,530 filed Dec. 24, 2003, which claims the benefit of U.S. Provisional Application 60/437,644, filed Jan. 02, 2003.

### BACKGROUND OF THE INVENTION

This invention is directed to a system and method for providing fee-based data services. More particular, this invention is directed to a system and method to allow users in a non-office environment to access and use data services for storage media based data, such as storing, printing, and distribution of such data, and to charge the users for such services.

Typically, professionals routinely work with documents or other data while away from their office environment. These professionals need to generate image data, by printing a document, and then to need to distribute or perform other functions on such image data. Multifunctions peripheral devices, such as printers and scanning devices, routinely perform such operations. However, there is no easy or cost effective way for these mobile users to use these existing technologies in a non-office environment or a public facility. In addition, in order for the user to access data located on a storage media, such as a USB storage medium, CD, DVD, or floppy disks, the user will have to access such data via a computer, personal digital assistant, or other such device. If the user does not have a computer or other device accessible to him, the user will not be able to access and use the data stored on the storage medium.

There is a need for system and method to provide fee-based data services for data stored on a data storage medium to users in a non-office environment.

### SUMMARY OF THE INVENTION

In accordance with the present invention, there is provided a system and method for providing fee-based data services for data stored on a data storage medium to users in a non-office environment.

Further, in accordance with the present invention, there is provided a system and method to allow users in a non-office environment to access and use data services for storage based data, such as printing, distribution, and storage such data and to charge the users for such services.

In the present invention, a user is provided access to a multifunctional peripheral device in a non-office environment, such an airport lounge or hotel business center. The user is provided information about the various services available, such as printing, distribution, storage, and the available payment options. The user selects the data for which the services are to be performed. The user inserts the storage media containing the data for which the user desires services into the multifunctional peripheral device or otherwise communicates such data with the Multifunctional peripheral device. The user then selects the appropriate payment option. The user then provides selected information about the service the user wants to be performed. The user is then presented with the total cost of the service. Upon the user accepting the charges, the service is performed. The details of the transaction are archived and the user is billed for the service.

These and other advantages, aspects, and features will be understood by one of ordinary skill in the art upon reading and understanding the specification.

### BRIEF DESCRIPTION OF THE DRAWINGS

FIG. 1 is a diagram illustrating a system for providing fee-based data services to users in a non-office environment according to the present invention.

FIG. 2 is flowchart of one embodiment for providing fee-based data services to users in a non-office environment according to the present invention.

FIG. 3 is flowchart of a second embodiment for providing fee-based data services to users in a non-office environment according to the present invention.

FIG. 4 is flowchart of a third embodiment for providing fee-based data services to users in a non-office environment according to the present invention.

### DETAILED DESCRIPTION OF THE PREFERRED EMBODIMENTS

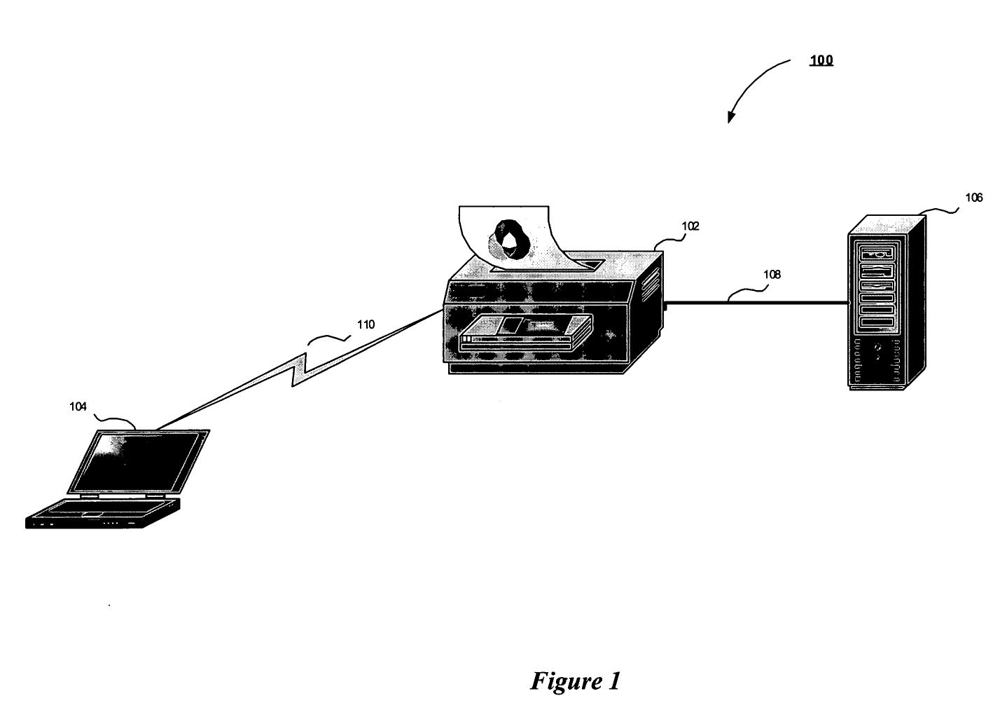

The present invention is directed to a system and method for providing fee-based data services to mobile users. A diagram illustrating the system 100 is shown in FIG. 1. In the present invention, a mobile user is provided access to a Multifunctional peripheral device 102 in a non-office environment, such as an airport lounge or business center. Other non-office environment locations include, but limited to, university campuses, conference centers, libraries, and hotels. The user accesses the multifunctional peripheral device 102 directly or via a computer or other suitable interface 104 via a suitable communication link 110. The multifunctional peripheral is connected to an associated central server 106 via a suitable communication link 108, such as the Internet. The user is then provided with information about the services available to be performed. The information is provided in any suitable manner known in the art. The information is suitably provided by way of a user interface associated with the Multifunctional peripheral device or documentation provided related thereto.

The services provided to the user are those typically provided by multifunctional peripheral devices and associated software. In one embodiment, the system allows the user to receive image data from a storage medium via the multifunctional peripheral device and then stores or archives such image data in an associated repository. In another embodiment, the system allows the user to receive image data from a storage medium via the multifunctional peripheral device, and then transmit the image data to at least one selected destination. In yet another embodiment, the system allows the user to receive image data from a storage medium via the Multifunctional peripheral and then to print the image data according to the parameters selected by the user.

The user is then provided with information about the available payment options for paying for the desired services. The payment options include any suitable payment options known in the art for charging for mobile fee-based services. Suitable payment options include, but are not limited to, credit cards, prepaid accounts, coupons, and partner accounts. These payment options can be suitably group accounts and individual accounts. The user then selects the desired payment option from the options provided. The requirements for paying the fees depend on the payment option selected. If the user selects the credit card option, the user is prompted to provide selected information about the user's credit card, such as credit card type, credit card number, the credit card holder's name, and the expiration date. The information is suitably provided by the user by any suitable means known in the art. Examples of such input are by direct user input via a keyboard interface or the like, or by access to a pre-stored information on a memory device, such as a magnetic strip, embedded data storage or an intelligent card. The information is then sent to the central server via the communication link for authentication and approval from the credit card company shown as 108. Such information is provided by the central server to the credit card company by any suitable method known in the art. Given that sensitive information is being transmitted, a suitable security encryption or authentication system, as will be readily appreciated by one of ordinary skill in the art, is advantageously used. The authentication of the information and the transaction approval is provided by any suitable method known in the art. Preferably, the user is informed of the status of the approval. Preferably, if the transaction is not approved, the user is requested to submit information for an alternative credit card. In one embodiment, the user's credit card is charged for every transaction at the time of the transaction. In another embodiment, the user's credit card is charged for the transactions monthly or other suitable periodic interval.

If the user selects the prepaid account option, the user is prompted to open a prepaid account by a suitable method known in the art. Preferably, the user is prompted to open the prepaid account via a web-enabled user interface at specified URL that is served by the central server. The user provides selected information about a credit card or other type of debit card to open the account. Upon authentication of the information and approval of the use of the credit card by any suitable means, the user is issued an account identification and associated password for the account. Information about the account is maintained in any suitable database or repository, preferably, on the central server. In one embodiment, the balance maintained in the user account is debited every time the user accesses services on the system. In another embodiment, the balance is debited every month or other suitable periodic interval. The user may replenish the account by any suitable means at any time.

If the user selects the coupon option, the user is prompted to provide selected information about the coupons, such as the coupon issuer and the coupon number. This information is sent to the central server by any suitable means known in the art. The authentication of the information and the transaction approval is provided by any suitable method known in the art. Preferably, the user is informed of the status of the approval. Preferably, if the transaction is not approved, the user is requested to correct the information or provide alternative information. Preferably, the user is provided information about any applicable limits or restrictions on services associated with the use of the coupons, such as the number of pages printed.

If the user selects the partner account option, the user is prompted to selected a third party account provider from a list of available options by any suitable means. Examples of partner accounts, include, but are not limited to, Sprint PCS, AOL, Liberty Alliance, MS Passport, and AT&T. The user is prompted to provide selected information about the account, such as the account or user identification, and password. The information is provided to the central server by any suitable means known in the art. Such information is provided by the central server to the partner company by any suitable method known in the art. The authentication of the information and the transaction approval is provided by any suitable method known in the art. Preferably, the user is informed of the status of the approval. Preferably, if the transaction is not approved, the user is requested to correct the information or provide alternative information. In one embodiment, the user's account is charged for every transaction at the time of the transaction. In another embodiment, the user's account is charged for the transactions monthly or other suitable periodic interval. After selecting the desired payment option, the user is prompted to provide selected information about the desired service to be performed. If the user desires generate or receive image data using the multifunctional peripheral device and then stores or archives such image data in an associated repository, the user is prompted to provide information related to the repository. For example, the user is requested to provide the name or URL of the repository, the user identification, password, and duration that the information is to be stored in the repository. If the user desires to generate or receive image data and then transmit the image data to at least one selected destination, the user is prompted to provide information about the at least one destination. If the user desires to generate or receive image data and then print the image data, the user is prompted to provide information about the parameters for printing the image data.

The user is then prompted to select the desired parameters for generating or receiving the image data. For example, if the user is printing a document, the user suitably provides information about the type of print job, color, dpi, and related information. After receiving such information, the system starts generating or receiving the image data. Preferably, after generating or receiving the image data, the system provides the user with the total cost associated with the selected services. It is understood however, that the total cost associated with the selected services may be provided to the user prior to generating or receiving the image data. Once the user has accepted the services by any suitable means known in the art, the services are performed. Preferably, the system provides a report of the status of the services to the user. Preferably, the user can view the results and make any needed changes to the services if the results are not acceptable. Information relating to the services is stored an associated repository, preferably located on the central server. The user is then billed for the services performed depending on the payment option selected by any suitable means known in the art. Preferably, a receipt is provided to the user upon completion of the services desired.

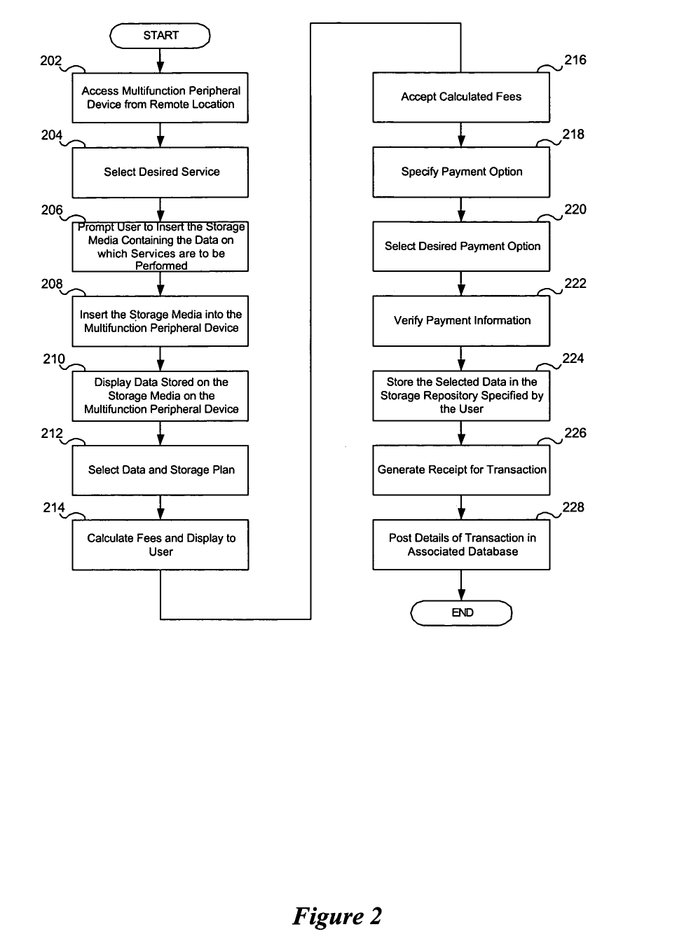

FIG. 2 shows a flowchart for providing fee-based data services to users in a non-office environment according to the present invention. In this embodiment, image data from is received from a storage medium via the Multifunctional peripheral device and then the image data is stored or archived in an associated repository. As shown at 202, a user is provided access to a Multifunctional peripheral device 102 in a non-office environment, such as an airport lounge or business center. The user accesses the multifunctional peripheral device via any suitable means, such as via a user interface associated with the Multifunctional peripheral device. The user is presented with a description of the service to store or archive storage medium based files on an associated repository and the available payment options. At 204, the user selects the desired service via any suitable means.

At 206, the user is prompted via any suitable means to insert the storage media containing the data for which the user desires services into the multifunctional peripheral device or to otherwise communicate such data with the Multifunctional peripheral device. Upon receiving such prompt, the user at 208 inserts the storage media into the Multifunctional peripheral device or otherwise communicates such data with the Multifunctional peripheral device.

At 210, the user is shown via any suitable means, such as via the user interface associated with the Multifunctional peripheral device, with a list of files or other data contained on the storage media and is prompted via any suitable means to select the files or data to be stored and to select a storage plan, such as daily or monthly plan charge. At 212, the user selects the files or data and specifies the storage plan via any suitable means.

At 214, the system calculates the appropriate charges via any suitable means and presents the charges to the user via any suitable means for user approval. At 216, the user accepts the transaction via any suitable means. At 218, the user is prompted to specify a payment option via any suitable means and to provide the necessary information for the associated payment option.

At 220, the user selects the desired payment option via any suitable means and provides the information required to effectuate such payment via any suitable means. At 222, the system verifies the payment information received from the user. Upon verification of the payment information as shown at 224, the system stores the files or data in the storage repository as specified by the user.

At 226, a receipt for the transaction is generated by the Multifunctional peripheral device. The details of the transaction are posted in an associated database via any suitable means for later retrieval as shown at 228.

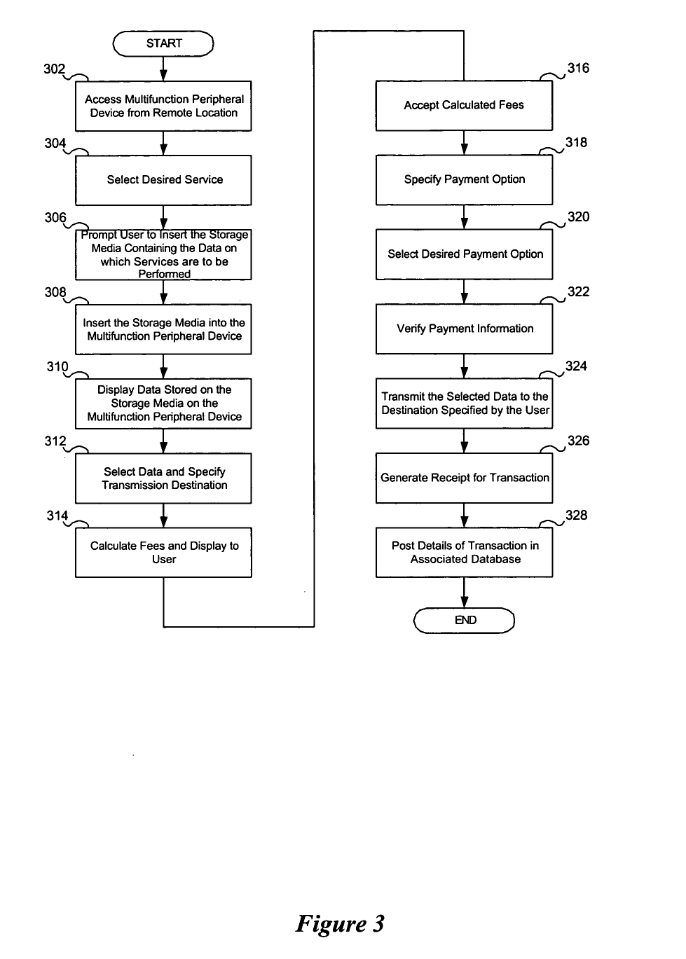

FIG. 3 shows a flowchart of a second embodiment for providing fee-based data services to users in a non-office environment according to the present invention. In this embodiment, image data from is received from a storage medium via the multifunctional peripheral device and then the image data is transmitted to at least one destination. As shown at 302, a user is provided access to a Multifunctional peripheral device 102 in a non-office environment, such as an airport lounge or business center. The user accesses the multifunctional peripheral device via any suitable means, such as via a user interface associated with the Multifunctional peripheral device. The user is presented with a description of the service to transmit the selected to at least one destination and the available payment options. At 304, the user selects the desired service via any suitable means.

At 306, the user is prompted via any suitable means to insert the storage media containing the data for which the user desires services into the multifunctional peripheral device or to otherwise communicate such data with the Multifunctional peripheral device. Upon receiving such prompt, the user at 308 inserts the storage media into the Multifunctional peripheral device or otherwise communicates such data with the multifunctional peripheral device.

At 310, the user is shown via any suitable means, such as via the user interface associated with the Multifunctional peripheral device, with a list of files or other data contained on the storage media and is prompted via any suitable means to select the files or data to transmitted and to select the destinations to which the data is to be transmitted, such as the electronic mail addresses or facsimile numbers. At 312, the user selects the files or data and specifies at least one destination via any suitable means.

At 314, the system calculates the appropriate charges via any suitable means and presents the charges to the user via any suitable means for user approval. At 316, the user accepts the transaction via any suitable means. At 318, the user is prompted to specify a payment option via any suitable means and to provide the necessary information for the associated payment option.

At 320, the user selects the desired payment option via any suitable means and provides the information required to effectuate such payment via any suitable means. At 322, the system verifies the payment information received from the user. Upon verification of the payment information as shown at 324, the system sends the files or data to the at least one destination as specified by the user.

At 326, a receipt for the transaction is generated by the Multifunctional peripheral device. The details of the transaction are posted in an associated database via any suitable means for later retrieval as shown at 328.

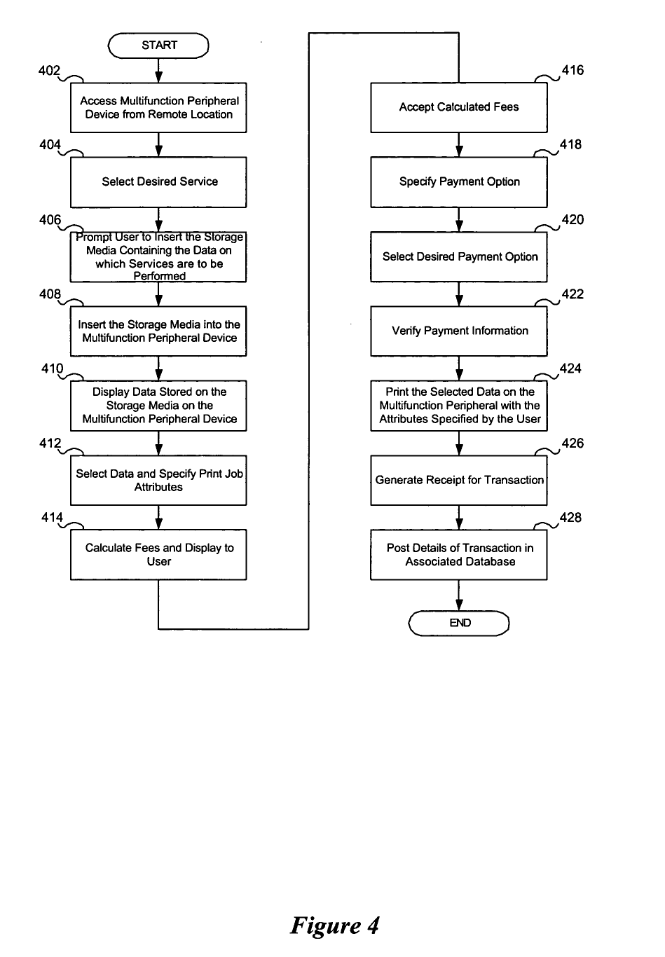

FIG. 4 shows a flowchart of a second embodiment for providing fee-based data services to users in a non-office environment according to the present invention. In this embodiment, image data from is received from a storage medium via the multifunctional peripheral device and then the image data is printed via the Multifunctional peripheral. As shown at 402, a user is provided access to a multifunctional peripheral device 102 in a non-office environment, such as an airport lounge or business center. The user accesses the multifunctional peripheral device via any suitable means, such as via a user interface associated with the multifunctional peripheral device. The user is presented with a description of the service to print the files or data and the available payment options. At 404, the user selects the desired service via any suitable means.

At 406, the user is prompted via any suitable means to insert the storage media containing the data for which the user desires services into the Multifunctional peripheral device or to otherwise communicate such data with the Multifunctional peripheral device. Upon receiving such prompt, the user at 408 inserts the storage media into the Multifunctional peripheral device or otherwise communicates such data with the Multifunctional peripheral device.

At 410, the user is shown via any suitable means, such as via the user interface associated with the multifunctional peripheral device, with a list of files or other data contained on the storage media and is prompted via any suitable means to select the files or data to be printed and specify the print job attributes, such as color, dpi, and duplexing. At 412, the user selects the files or data and specifies the print job attributes via any suitable means.

At 414, the system calculates the appropriate charges via any suitable means and presents the charges to the user via any suitable means for user approval. At 416, the user accepts the transaction via any suitable means. At 418, the user is prompted to specify a payment option via any suitable means and to provide the necessary information for the associated payment option.

At 420, the user selects the desired payment option via any suitable means and provides the information required to effectuate such payment via any suitable means. At 422, the system verifies the payment information received from the user. Upon verification of the payment information as shown at 424, the system prints the files or data as specified by the user.

At 426, a receipt for the transaction is generated by the Multifunctional peripheral device. The details of the transaction are posted in an associated database via any suitable means for later retrieval as shown at 428.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention.

What is claimed is:

1. A system for providing fee-based access to shared data peripheral devices comprising:
a data peripheral system comprising at least one data input/output device;
data communication means adapted for receiving a data storage medium so as to communicate data stored therein to the at least one data input/output device;
accounting means adapted for securing charge information from an associated user, which charge information allows for securing of payment for use of a selected data processing operation of the data peripheral system undertaken in connection with data received from the data storage medium;
verification means adapted for securing charge verification information corresponding to charge information received from the associated user; and
enabling means adapted for enabling operation of the data peripheral system in accordance with an output of the verification means so as to provide fee-based access of the associated user to the peripheral system.

2. The system of claim 1 wherein the data peripheral system includes at least one of a printer, facsimile, scanning device, character recognition system, and storage device.

3. The system of claim 1 wherein the selected data processing operation undertaken in connection with the data received from the data storage medium is at least one of printing selected data received from the data storage medium, storing selected data received from the data storage medium in a selected storage medium located in the data peripheral system, and transmitting selected data received from the data storage medium to at least one selected destination.

4. The system of claim 1 further comprising means adapted for selecting parameters for the selected data processing operation undertaken in connection with the data received from the data storage medium.

5. The system of claim 1 further comprising means adapted for user selection of data to be received from the data storage medium for the selected data processing operation.

6. The system of claim 2 wherein the charge information includes information associated with at least one of a pre-paid debit card, coupon, and credit card.

7. The system of claim 1 wherein the data storage medium is at least one of a USB storage medium, random access memory, disk memory, flash memory, and read only memory.

8. The system of claim 1 further comprising tracking means adapted for tracking the user's usage of the data peripheral system and cost generating means adapted for receiving an output from the tracking means and generating a cost for the user's usage of the data peripheral system.

9. The system of claim 8 further comprising billing means adapted for receiving an output from the cost generating means and applying the output to the user's charge information.

10. A method for providing fee-based access to shared data peripheral devices comprising the steps of:
receiving a data storage medium so as to communicate data stored therein to at least one data input/output device within a data peripheral system;
securing charge information from an associated user, which charge information allows for securing of payment for use of a selected data processing operation of the data peripheral system undertaken in connection with data received from the data storage medium;
securing charge verification information corresponding to charge information received from the associated user; and
enabling operation of the data peripheral system in accordance with an output of the verification means so as to provide fee-based access of the associated user to the peripheral system.

11. The method of claim 10 wherein the data peripheral system includes at least one of a printer, facsimile, scanning device, character recognition system, and storage device.

12. The method of claim 10 wherein the selected data processing operation undertaken in connection with the data received from the data storage medium is at least one of printing selected data received from the data storage medium, storing selected data received from the data storage medium in a selected storage medium located in the data peripheral system, and transmitting selected data received from the data storage medium to at least one selected destination.

13. The method of claim 10 further comprising the step of selecting parameters for the selected data processing operation undertaken in connection with the data received from the data storage medium.

14. The method of claim 10 further comprising the step of user selection of data to be received from the data storage medium for the selected data processing operation.

15. The method of claim 11 wherein the charge information includes information associated with at least one of a pre-paid debit card, coupon, and credit card.

16. The method of claim 10 wherein the data storage medium is at least one of a USB storage medium, random access memory, disk memory, flash memory, and read only memory.

17. The method of claim 10 further comprising the steps of:
tracking the user's usage of the data peripheral system; and
receiving an output from the tracking means and generating a cost for the user's usage of the data peripheral system.

18. The method of claim 17 further comprising the step of receiving an output from the cost generating means and applying the output to the user's charge information.

19. A computer-readable medium for providing fee-based access to shared data peripheral devices comprising:
a data peripheral system comprising at least one data input/output device;
data communication means adapted for receiving a data storage medium so as to communicate data stored therein to the at least one data input/output device;
accounting means adapted for securing charge information from an associated user, which charge information allows for securing of payment for use of a selected data processing operation of the data peripheral system undertaken in connection with data received from the data storage medium;
verification means adapted for securing charge verification information corresponding to charge information received from the associated user; and
enabling means adapted for enabling operation of the data peripheral system in accordance with an output of the verification means so as to provide fee-based access of the associated user to the peripheral system.

20. The computer-readable medium of claim 19 wherein the data peripheral system includes at least one of a printer, facsimile, scanning device, character recognition system, and storage device.

21. The computer-readable medium of claim 19 wherein the selected data processing operation undertaken in connection with the data received from the data storage medium is at least one of printing selected data received from the data storage medium, storing selected data received from the data storage medium in a selected storage medium located in the data peripheral system, and transmitting selected data received from the data storage medium to at least one selected destination.

22. The computer-readable medium of claim 19 wherein the data storage medium is at least one of a USB storage medium, random access memory, disk memory, flash memory, and read only memory.

23. The computer-readable medium of claim 19 further comprising tracking means adapted for tracking the user's usage of the data peripheral system and cost generating means adapted for receiving an output from the tracking means and generating a cost for the user's usage of the data peripheral system.

24. The computer-readable medium of claim 23 further comprising billing means adapted for receiving an output from the cost generating means and applying the output to the user's charge information.

25. A computer-implemented method for providing fee-based access to shared data peripheral devices comprising the steps of:
receiving a data storage medium so as to communicate data stored therein to at least one data input/output device within a data peripheral system;
securing charge information from an associated user, which charge information allows for securing of payment for use of a selected data processing operation of the data peripheral system undertaken in connection with data received from the data storage medium;
securing charge verification information corresponding to charge information received from the associated user; and
enabling operation of the data peripheral system in accordance with an output of the verification means so as to provide fee-based access of the associated user to the peripheral system.

26. The computer-implemented method of claim 25 wherein the data peripheral system includes at least one of a printer, facsimile, scanning device, character recognition system, and storage device.

27. The computer-implemented method of claim 25 wherein the selected data processing operation undertaken in connection with the data received from the data storage medium is at least one of printing selected data received from the data storage medium, storing selected data received from the data storage medium in a selected storage medium located in the data peripheral system, and transmitting selected data received from the data storage medium to at least one selected destination.

28. The computer-implemented method of claim 25 wherein the data storage medium is at least one of a USB storage medium, random access memory, disk memory, flash memory, and read only memory.

29. The computer-implemented method of claim 25 further comprising the steps of:
tracking the user's usage of the data peripheral system; and
receiving an output from the tracking means and generating a cost for the user's usage of the data peripheral system.

30. The computer-implemented method of claim 29 further comprising the step of receiving an output from the cost generating means and applying the output to the user's charge information.
